(19) United States
(12) Patent Application Publication
(10) Pub. No.: US 2026/0281958 A1
(43) Pub. Date: Sep. 17, 2026

(54) GNSS MEASUREMENT METHOD, TERMINAL, NETWORK-SIDE DEVICE, AND READABLE STORAGE MEDIUM

(71) Applicant: VIVO MOBILE COMMUNICATION CO., LTD., Dongguan (CN)

(72) Inventors: Ranran HE, Dongguan (CN); Yanxia ZHANG, Dongguan (CN); Yitao MO, Dongguan (CN)

(73) Assignee: VIVO MOBILE COMMUNICATION CO., LTD., Dongguan (CN)

(21) Appl. No.: 19/665,690

(22) Filed: May 1, 2026

Related U.S. Application Data
(63) Continuation of application No. PCT/CN2024/136414, filed on Dec. 3, 2024.

(30) Foreign Application Priority Data
Nov. 3, 2023 (CN) 202311465855.7

(51) Int. Cl. H04W 64/00; H04W 76/19; H04W 76/20

(52) U.S. Cl. CPC H04W 64/00; H04W 76/19; H04W 76/20

(57) ABSTRACT

A global navigation satellite system (GNSS) measurement method includes: when a first condition is met, a terminal executing GNSS measurement, wherein the first condition comprises any one of the following: the terminal having received a first instruction and first time information which are sent by a network-side device, the terminal having received the first instruction sent by the network-side device, and the terminal having received the first time information sent by the network-side device, the first instruction being used for instructing the network-side device to enable GNSS measurement of the terminal, and the first time information being time information for the terminal to execute GNSS measurement.

### CROSS-REFERENCE TO RELATED APPLICATIONS

This application is a continuation of PCT application No. PCT/CN2024/136414 filed Dec. 3, 2024, which claims priority to Chinese Patent Application No. 202311465855.7, filed in China on Nov. 3, 2023. The foregoing applications are incorporated herein by reference in their entireties.

### TECHNICAL FIELD

This application belongs to the technical field of wireless communication, and specifically relates to a global navigation satellite system (GNSS) measurement method, terminal, network-side device, and readable storage medium.

### BACKGROUND

In some communication scenarios, a terminal needs to perform GNSS measurement to obtain GNSS positioning. A prerequisite for the terminal to perform GNSS measurement includes that the terminal can perform GNSS measurement (for example, a network has enabled or activated the terminal to perform GNSS measurement) and that the terminal has obtained time for performing GNSS measurement.

In the related technology, a network side can send GNSS measurement related information by using two types of messages (for example, radio resource control (RRC) signaling and media access control (MAC) control element (CE)), but it is still unclear when the terminal activates a GNSS measurement function (that is, it is unclear when the terminal can perform GNSS measurement).

### SUMMARY

Embodiments of this application provide a GNSS measurement method, terminal, network-side device, and readable storage medium, to resolve a problem of how to determine an opportunity for a terminal to activate a GNSS measurement function.

According to a first aspect, a GNSS measurement method is provided. The method includes:

A terminal performs GNSS measurement under the condition of a first condition being satisfied.

The first condition includes any one of the following:

The terminal has received a first indication and first time information that are sent by a network-side device;
the terminal has received a first indication sent by a network-side device; or
the terminal has received first time information sent by a network-side device.

The first indication indicates that the network-side device enables GNSS measurement of the terminal, and the first time information is time information for the terminal to perform GNSS measurement.

According to a second aspect, a GNSS measurement method is provided. The method includes:

A network-side device sends at least one of the following to a terminal: a first indication and first time information.

The first indication indicates that the network-side device enables GNSS measurement of the terminal, and the first time information is time information for the terminal to perform GNSS measurement.

That the first indication is received is a first condition for the terminal to perform GNSS measurement, or that the first indication and the first time information are received is a first condition for the terminal to perform GNSS measurement, or that the first time information is received is a first condition for the terminal to perform GNSS measurement.

According to a third aspect, a GNSS measurement apparatus is provided, including:
a first processing module, configured to perform GNSS measurement under the condition of a first condition being satisfied.

The first condition includes any one of the following:
The terminal has received a first indication and first time information that are sent by a network-side device;
the terminal has received a first indication sent by a network-side device; or
the terminal has received first time information sent by a network-side device.

The first indication indicates that the network-side device enables GNSS measurement of the terminal, and the first time information is time information for the terminal to perform GNSS measurement.

According to a fourth aspect, a GNSS measurement apparatus is provided, including:
a first sending module, configured to send at least one of the following to a terminal: a first indication and first time information.

The first indication indicates that the network-side device enables GNSS measurement of the terminal, and the first time information is time information for the terminal to perform GNSS measurement.

That the first indication is received is a first condition for the terminal to perform GNSS measurement, or that the first indication and the first time information are received is a first condition for the terminal to perform GNSS measurement, or that the first time information is received is a first condition for the terminal to perform GNSS measurement.

According to a fifth aspect, a terminal is provided. The terminal includes a processor and a memory. The memory stores a program or instructions runnable on the processor; and when executed by the processor, the program or instructions implement the steps of the method according to the first aspect.

According to a sixth aspect, a terminal is provided, including a processor and a communication interface. The processor is configured to perform GNSS measurement under the condition of a first condition being satisfied.

The first condition includes any one of the following:
The terminal has received a first indication and first time information that are sent by a network-side device;
the terminal has received a first indication sent by a network-side device; or
the terminal has received first time information sent by a network-side device.

The first indication indicates that the network-side device enables GNSS measurement of the terminal, and the first time information is time information for the terminal to perform GNSS measurement.

According to a seventh aspect, a network-side device is provided. The network-side device includes a processor and a memory. The memory stores a program or instructions runnable on the processor; and when executed by the processor, the program or instructions implement the steps of the method according to the second aspect.

According to an eighth aspect, a network-side device is provided, including a processor and a communication interface. The communication interface is configured to send at least one of the following to a terminal: a first indication and first time information.

The first indication indicates that the network-side device enables GNSS measurement of the terminal, and the first time information is time information for the terminal to perform GNSS measurement.

That the first indication is received is a first condition for the terminal to perform GNSS measurement, or that the first indication and the first time information are received is a first condition for the terminal to perform GNSS measurement, or that the first time information is received is a first condition for the terminal to perform GNSS measurement.

According to a ninth aspect, a readable storage medium is provided. A program or instructions are stored on the readable storage medium; and when executed by a processor, the program or instructions implement the steps of the method according to the first aspect, or implement the steps of the method according to the second aspect.

According to a tenth aspect, a wireless communication system is provided, including: a terminal and a network-side device. The terminal may be configured to perform the steps of the GNSS measurement method according to the first aspect, and the network-side device may be configured to perform the steps of the GNSS measurement method according to the second aspect.

According to an eleventh aspect, a chip is provided. The chip includes a processor and a communication interface. The communication interface is coupled to the processor. The processor is configured to run a program or instructions to implement the GNSS measurement method according to the first aspect, or to implement the GNSS measurement method according to the second aspect.

According to a twelfth aspect, a computer program/program product is provided. The computer program/program product is stored in a storage medium, and the program/program product is executed by at least one processor to implement the steps of the GNSS measurement method according to the first aspect or the second aspect.

In embodiments of this application, it is clarified when the terminal can perform GNSS measurement, or in other words, when to activate a GNSS measurement function, so that the terminal can perform GNSS measurement in a timely manner, avoiding a communication fault caused by out-of-date GNSS positioning.

### BRIEF DESCRIPTION OF DRAWINGS

FIG. 1 is a block diagram of a wireless communication system to which an embodiment of this application is applicable;

FIG. 2 is a schematic flowchart of a GNSS measurement method performed by a terminal according to an embodiment of this application;

FIG. 3 is a schematic flowchart of a GNSS measurement method performed by a network-side device according to an embodiment of this application;

FIG. 4 is a first schematic diagram of a structure of a GNSS measurement apparatus according to an embodiment of this application;

FIG. 5 is a second schematic diagram of a structure of a GNSS measurement apparatus according to an embodiment of this application;

FIG. 6 is a schematic diagram of a structure of a communication device according to an embodiment of this application;

FIG. 7 is a schematic diagram of a hardware structure of a terminal according to an embodiment of this application; and

FIG. 8 is a schematic diagram of a hardware structure of a network-side device according to an embodiment of this application.

### DETAILED DESCRIPTION

The technical solutions in embodiments of this application are clearly described below with reference to the drawings in embodiments of this application. It is clear that the described embodiments are a part of embodiments of this application, not all of them. All other embodiments obtained by persons of ordinary skill in the art based on embodiments in this application without creative efforts belong to the scope of protection of this application.

The terms “first”, “second” and the like in this application are used to distinguish between similar objects, but are not used to describe a specific order or sequence. It should be understood that the terms used in this way are interchangeable as appropriate, so that embodiments of this application can be implemented in sequences other than those illustrated or described herein. The objects distinguished by “first” and “second” are usually of one type, and a quantity of objects is not limited. For example, there may be one or more first objects. In addition, the “or” in this application indicates at least one of the connected objects. For example, “A or B” includes three schemes: scheme one: including A but not including B; scheme two: including B but not including A; and scheme three: including both A and B. The character “/” generally indicates that the preceding and following associated objects are in an “or” relationship.

The term “indication” in this application may be a direct indication (or explicit indication) or an indirect indication (or implicit indication). The direct indication may be understood as that a sender explicitly informs a receiver of content such as specific information, an operation that needs to be performed, or a requested result in the sent indication. The indirect indication may be understood as that the receiver determines corresponding information based on the indication sent by the sender, or performs determining and determines the operation that needs to be performed or the requested result based on a result of determining.

It should be noted that the technology described in embodiments of this application is not limited to long term evolution (LTE)/LTE-advanced (LTE-A) system, and may also be used in another wireless communication system such as code division multiple access (CDMA) system, time division multiple access (TDMA) system, frequency division multiple access (FDMA) system, orthogonal frequency division multiple access (OFDMA) system, single-carrier frequency-division multiple access (SC-FDMA) system, or another system. The terms “system” and “network” in embodiments of this application are often used interchangeably, and the described technology can be used not only in the above-mentioned systems and radio technologies, but also in other systems and radio technologies. The following description describes new radio (NR) system for purposes of examples, and uses NR terminology in most of the following descriptions, but these technologies can also be applied to systems other than the NR system, such as 6^{th} generation (6G) communication system.

Some technical contents involved in this application are briefly introduced below.

### (1) Non-Terrestrial Network (NTN)

For the NTN, the standard definition given by the 3rd generation partnership project (3GPP) is “a network or network segment using airborne or space launch vehicles to carry transmission equipment relay nodes or base stations”. Simply, it is a general term for any network involving non-terrestrial vehicles, including satellite communication networks and high altitude platform systems (High Altitude Platform systems, HAPs). NTN enables traditional 3GPP terrestrial networks to break through limitations of the earth's surface and extend to natural space such as the air, ocean, and land. Because the current 3GPP work focus has always been around satellite communication networks, narrow-sense NTN mainly refers to satellite communications.

### (2) GNSS Measurement in Connected Mode

In an NTN scenario, a terminal needs to perform GNSS measurement to obtain GNSS positioning. In R17 internet of things NTN (IoT-NTN), performing GNSS measurement and narrow band internet of things (NB-IoT)/enhanced machine type communication (eMTC) data transmission operations simultaneously is not supported. The terminal can perform GNSS measurement only in RRC idle mode (RRC_IDLE). If the terminal's GNSS positioning is out-of-date, the terminal has to enter RRC idle mode to perform a GNSS measurement operation. To enable the terminal in RRC connected mode to perform GNSS measurement, R18 IoT-NTN introduces two mechanisms: network-triggered GNSS measurement and autonomous GNSS measurement.

FIG. 1 is a block diagram of a wireless communication system to which an embodiment of this application is applicable. The wireless communication system includes a terminal 11, a satellite 12, and an NTN gateway 13. The terminal 11 communicates with the satellite 12 through a service link, the satellite 12 communicates with the NTN gateway 13 through a feeder link, and the NTN gateway 13 communicates with a data network. It should be noted that quantities of the communication devices in the wireless communication system shown in FIG. 1 are only an example. The quantities of the communication devices may alternatively be in plural, and a connection relationship may change according to actual conditions. The example in FIG. 1 is not intended to limit the wireless communication system provided by this embodiment of this application. For example, FIG. 1 only shows one terminal 11. In some embodiments, there may be more terminals 11 in the wireless communication system shown in FIG. 1 that communicate with the satellite 12.

The terminal 11 may be a mobile phone, a tablet computer, a laptop computer, a notebook computer, a personal digital assistant (PDA), a palmtop computer, a netbook, an ultra-mobile personal computer (UMPC), a mobile internet device (MID), an augmented reality (AR) or virtual reality (VR) device, a robot, a wearable device, a flight vehicle, vehicle user equipment (VUE), a ship-borne device, pedestrian user equipment (PUE), a smart home (a home device with a wireless communication function, such as a refrigerator, a TV, a washing machine, or furniture), a game console, a personal computer (PC), an automated teller machine, a self-service machine, or another terminal-side device. The wearable device includes a smart watch, a smart band, a smart headphone, smart glasses, smart jewelry (a smart bracelet, a smart hand chain, a smart ring, a smart necklace, a smart anklet, a smart foot chain, or the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application.

The GNSS measurement method, terminal, network-side device, and readable storage medium provided by embodiments of this application are described in detail below by using some embodiments and application scenarios thereof with reference to the accompanying drawings.

It should be noted that each embodiment of this application is applicable to a non-terrestrial network (NTN) scenario, and is also applicable to other scenarios that require GNSS measurement, such as terrestrial network scenarios or integrated space-air-ground scenarios.

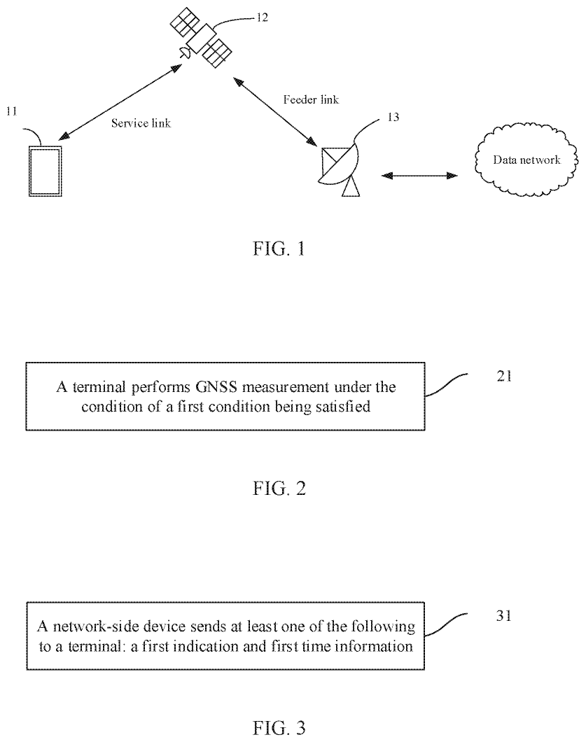

Refer to FIG. 2. An embodiment of this application provides a GNSS measurement method. The method includes:

Step 21: A terminal performs GNSS measurement under the condition of a first condition being satisfied.

The first condition includes any one of the following:
The terminal has received a first indication and first time information that are sent by a network-side device;
the terminal has received a first indication sent by a network-side device; or
the terminal has received first time information sent by a network-side device.

The first indication indicates that the network-side device enables GNSS measurement of the terminal, and the first time information is time information for the terminal to perform GNSS measurement.

In embodiments of this application, GNSS measurement may also be referred to as GNSS obtaining or GNSS re-obtaining, that is, obtaining or re-obtaining of GNSS positioning.

That the terminal performs GNSS measurement may also be understood as: The terminal is enabled to perform GNSS measurement.

In embodiments of this application, optionally, the terminal is in RRC connected mode, and the terminal performs GNSS measurement under the condition of the first condition being satisfied. That is, the terminal may be a terminal in RRC connected mode, and the terminal has a capability of performing GNSS measurement in connected mode. The GNSS measurement in embodiments of this application may be GNSS measurement performed by the terminal in RRC connected mode.

In embodiments of this application, optionally, the network-side device may be a network-side device in an NTN network, for example, a satellite, an uncrewed aerial vehicle or aircraft, or a ground base station connected to a satellite.

In embodiments of this application, the first indication may be gnss-AutonomousEnabled.

Optionally, the first indication may be carried by using an RRC message. The RRC message may include at least one of the following: an RRC connection setup (RRCConnectionSetup) message, an RRC connection resume (RRCConnectionResume) message, an RRC connection reestablishment (RRCConnectionReestablishment) message, and an RRC connection reconfiguration (RRCConnectionReconfiguration) message.

In embodiments of this application, optionally, the first time information is time information configured by the network-side device for the terminal to perform GNSS measurement and based on a time period required for GNSS measurement and reported by the terminal. Optionally, the first time information includes time length information, and the time length information in the first time information is greater than or equal to the time period required for GNSS measurement and reported by the terminal, to meet a time requirement for the terminal to perform GNSS measurement. In embodiments of this application, optionally, that the terminal performs GNSS measurement may also be described as: The GNSS measurement function is activated.

In embodiments of this application, optionally, that the terminal skips performing GNSS measurement may also be described as: A GNSS measurement function is not activated. It can be understood that the terminal skips performing GNSS measurement includes any one of the following: skipping performing autonomous GNSS measurement and network-triggered GNSS measurement, skipping performing autonomous GNSS measurement, and skipping performing network-triggered GNSS measurement.

In embodiments of this application, it is clarified when the terminal can perform GNSS measurement, or in other words, when to activate the GNSS measurement function, so that the terminal can perform GNSS measurement in a timely manner, avoiding a communication fault caused by out-of-date GNSS positioning.

In embodiments of this application, optionally, the first time information is carried by using an RRC message or a MAC CE. The MAC CE may include a GNSS measurement command MAC CE. The RRC message may include at least one of the following: an RRC connection setup (RRCConnectionSetup) message, an RRC connection resume (RRCConnectionResume) message, an RRC connection reestablishment (RRCConnectionReestablishment) message, and an RRC connection reconfiguration (RRCConnectionReconfiguration) message.

In embodiments of this application, optionally, the first time information includes time length information, that is, the terminal can perform GNSS measurement within the time length.

In embodiments of this application, optionally, the first time information is timer information, time interval (gap) information, time window (Windows) information, or period information. When the first time information includes the timer information, the timer information may include a length of a timer, and the timer is started when the terminal performs GNSS measurement. If the timer does not expire and the terminal completes GNSS measurement, the timer stops. If the timer expires but the terminal has not completed the GNSS measurement, it is considered that GNSS measurement fails.

In embodiments of this application, optionally, under the condition of the first condition including that the terminal has received the first indication and the first time information that are sent by the network-side device, the method further includes: Under the condition of the first indication sent by the network-side device being received but the first time information sent by the network-side device being not received, the terminal skips performing GNSS measurement. In other words, the terminal is not enabled to perform GNSS measurement or enable GNSS measurement is not applicable (enable GNSS measurement is not applicable). That is, in embodiments of this application, the terminal does not activate the GNSS measurement function upon receiving only the first indication, but activates the GNSS measurement function after receiving the first time information.

Therefore, under the condition of the terminal capable of performing GNSS measurement, an embodiment of this application provides a specific solution for the terminal to obtain time information and perform GNSS measurement based on the time information.

A process of performing, by the terminal, GNSS measurement is as follows: The terminal receives signals transmitted by a satellite to the ground at a precise time interval, a position of the satellite can be found in a satellite ephemeris, and a distance from the terminal to the satellite can be obtained based on time for propagating the signal transmitted by the satellite to the user multiplying by the speed of light. By integrating data from multiple satellites, the position of the terminal can be determined, which is known as GNSS positioning. Due to mobility of the terminal and the satellite, GNSS positioning usually has valid time. Exceeding this valid time means that GNSS positioning is invalid or out-of-date.

In embodiments of this application, optionally, the GNSS measurement method further includes: Under the condition of the terminal skipping performing GNSS measurement and GNSS positioning of the terminal being out of date (Out-of-date), the terminal performs at least one of the following operations:
leaving RRC connected mode; and
entering RRC idle mode (RRC_IDLE).

In embodiments of this application, GNSS positioning being out-of-date may also be described as: GNSS positioning is invalid.

Because GNSS positioning is out-of-date and the terminal cannot perform GNSS measurement, the terminal needs to leave RRC connected mode and enter RRC idle mode.

In embodiments of this application, optionally, under the condition of the first condition including that the terminal has received the first indication and the first time information that are sent by the network-side device, the method further includes: The terminal performs GNSS measurement based on the first time information.

Optionally, the terminal performs GNSS measurement based on the time length information indicated by the first time information. That is, the terminal can use the time length information to perform GNSS measurement. It can be understood that the terminal can perform GNSS measurement within a time period indicated by the time length information. If the terminal completes GNSS measurement within the time period indicated by the time length information, the terminal may trigger a process of reporting valid duration of GNSS. If the terminal does not complete GNSS measurement within the time period indicated by the time length information, it is considered that GNSS measurement fails.

Optionally, the method further includes at least one of the following:
Time for the performing GNSS measurement is within a time period in which an inactive state of connected mode discontinuous reception (C-DRX) of the terminal is located (a specific time point can be determined based on terminal implementation); and
a start time point for the performing GNSS measurement is a time point at which the first time information is received.

In embodiments of this application, when the terminal completes GNSS measurement, reporting of remaining valid duration of GNSS can be triggered.

In some embodiments, the first condition includes that the terminal has received the first indication sent by the network-side device, that is, once the terminal has received the first indication, it is considered that the GNSS measurement function is activated. However, under the condition of the first condition including that the terminal has received the first indication sent by the network-side device, how to determine the time information for the terminal to perform GNSS measurement is a problem that needs to be resolved.

In embodiments of this application, optionally, under the condition of the first condition including that the terminal has received the first indication sent by the network-side device, the method further includes:

Under the condition of the first time information sent by the network-side device being not received, the terminal obtains second time information. The second time information is time information for the terminal to perform GNSS measurement.

Optionally, the terminal obtains the second time information in one of the following ways:
(1) Third time information is used as the second time information, where the third time information is agreed upon by a protocol, for example, a time period agreed upon by a protocol is 31 seconds.

In embodiments of this application, optionally, the second time information includes time length information.

In embodiments of this application, optionally, the time length information includes timer information, time interval information, time window information, or period information.
(2) Most recently reported fourth time information is used as the second time information, where the fourth time information is time information required for the terminal to perform GNSS measurement.

In embodiments of this application, optionally, the fourth time information is the fourth time information reported by the terminal to a currently connected network or a most recently connected network. The most recently connected network may also be referred to as a most recently previously connected network.
(3) Fifth time information is used as the second time information, where the fifth time information is configured by the network-side device.

In embodiments of this application, optionally, the fifth time information is carried by using an RRC message.

In embodiments of this application, optionally, under the condition of the first indication being carried by using a first RRC message, the first RRC message further carries the fifth time information. The first RRC message may include at least one of the following: an RRC connection setup (RRCConnectionSetup) message, an RRC connection resume (RRCConnectionResume) message, an RRC connection reestablishment (RRCConnectionReestablishment) message, and an RRC connection reconfiguration (RRCConnectionReconfiguration) message. It can be understood that under the condition of the first RRC message carrying the first indication, the first RRC message has to carry the fifth time information. In other words, if the first indication is included in the first RRC message, the fifth time information has to be included in the first RRC message.

With the method of embodiments of this application, it is clarified when the terminal activates the GNSS measurement function (that is, when the terminal can perform GNSS measurement). Under the condition of the GNSS measurement function being activated when the terminal considers that a network-side enable GNSS measurement configuration is received, it is clarified how the terminal obtains a time length for performing GNSS measurement. This enables the terminal to perform GNSS measurement upon receiving the network-side enable GNSS measurement configuration. It should be noted that exact time for the terminal to perform GNSS measurement is based on terminal implementation.

In embodiments of this application, optionally, under the condition of the second time information being obtained by using the fifth time information as the second time information, the method further includes:

Under the condition of the fifth time information configured by the network-side device being not received, the terminal performs at least one of the following operations:
considering a value of the second time information to be 0;
skipping performing GNSS measurement;
considering that a current camped or connected cell is barred from camping or connection;
leaving RRC connected mode; and
entering RRC idle mode (RRC_Idle).

In embodiments of this application, optionally, the GNSS measurement method further includes: after the terminal leaves RRC connected mode or enters RRC idle mode, under the condition of remaining valid time of GNSS positioning being less than or equal to a preset time threshold, skipping initiating at least one of the following operations: connection setup, connection resume, connection reestablishment, handover. The preset time threshold may be agreed upon by a protocol or configured by a network side. That is, if the remaining valid time of GNSS positioning is less than or equal to the preset time threshold, it indicates that the remaining valid time of GNSS positioning is short, and may become invalid after performing an operation such as initial access or connection resume or connection reestablishment or handover. At this time, there is no need to initiate an operation such as initial access or connection resume or connection reestablishment or handover.

In embodiments of this application, optionally, the GNSS measurement method further includes: The terminal performs GNSS measurement based on the second time information.

Optionally, the terminal performs GNSS measurement based on the time length information indicated by the second time information. That is, the terminal can perform GNSS measurement by using the time length information. It can be understood that the terminal can perform GNSS measurement within a time period indicated by the time length information. If the terminal completes GNSS measurement within the time period indicated by the time length information, the terminal may trigger a process of reporting valid duration of GNSS. If the terminal does not complete GNSS measurement within the time period indicated by the time length information, it is considered that GNSS measurement fails.

Optionally, a start time point for the performing GNSS measurement is within a time period in which an inactive state of connected mode discontinuous reception of the terminal is located, and the specific time point can be determined based on terminal implementation. In embodiments of this application, when the terminal completes GNSS measurement, reporting of remaining valid duration of GNSS can be triggered.

In embodiments of this application, optionally, the GNSS measurement method further includes: After the terminal obtains the second time information, under the condition of the first time information sent by the network-side device being received, the terminal performs GNSS measurement based on the first time information. That is, the network-side device can update the time length for the terminal to perform GNSS measurement. Optionally, the first time information can be carried by using a MAC CE.

In embodiments of this application, optionally, GNSS measurement includes at least one of the following:
autonomous GNSS measurement; and
network-triggered GNSS measurement.

A process of network-triggered GNSS measurement is as follows:
(1) In an initial access/connection resume/connection reestablishment/handover process, the terminal reports GNSS-ValidityDuration (indicating remaining valid duration of the terminal's GNSS positioning) and GNSS-PositionFixDuration (indicating a time period required for the terminal to perform GNSS measurement) by using message 5 (Msg5).
(2) The network side can send the MAC CE to trigger the terminal to perform GNSS measurement during a GNSS measurement gap, where a value of the GNSS measurement gap is indicated by the MAC CE.
(3) After successfully performing GNSS measurement, the terminal reports the remaining valid duration of the terminal's GNSS positioning by using the MAC CE.

A process of autonomous GNSS measurement is as follows:
(1) The terminal can perform autonomous GNSS measurement within the time period in which the inactive state of connected mode discontinuous reception (C-DRX) is located, where an exact start time point of GNSS measurement is determined based on implementation.
(2) After successfully performing GNSS measurement, the terminal reports the remaining valid duration of the terminal's GNSS positioning by using the MAC CE.

It should be noted that the terminal in embodiments of this application is a terminal with a GNSS measurement capability, for example, NB-IoT user equipment (UE) or eMTC UE.

Refer to FIG. 3. An embodiment of this application further provides a GNSS measurement method. The method includes:
Step 31: A network-side device sends at least one of the following to a terminal: a first indication and first time information.

The first indication indicates that the network-side device enables GNSS measurement of the terminal, and the first time information is time information for the terminal to perform GNSS measurement.

That the first indication is received is a first condition for the terminal to perform GNSS measurement, or that the first indication and the first time information are received is a first condition for the terminal to perform GNSS measurement, or that the first time information is received is a first condition for the terminal to perform GNSS measurement.

In embodiments of this application, optionally, the first time information is time information that is configured by the network-side device for the terminal based on the received time period required for GNSS measurement and reported by the terminal, and for the terminal to perform GNSS measurement.

In embodiments of this application, optionally, the first time information is carried by using an RRC message or a MAC CE.

In embodiments of this application, optionally, the first time information includes time length information.

In embodiments of this application, optionally, the GNSS measurement method further includes: The network-side device sends fifth time information to the terminal. The fifth time information is time information that is configured by the network-side device for the terminal under the condition of the first time information being not sent and for the terminal to perform GNSS measurement.

In embodiments of this application, optionally, the fifth time information includes time length information.

In embodiments of this application, optionally, the time length information includes timer information, time interval information, time window information, or period information.

In embodiments of this application, optionally, the GNSS measurement method further includes at least one of the following:

The network-side device sends a first request to a network-side device to which the terminal is most recently connected, where the first request is used to request time information required for GNSS measurement and reported by the terminal; and
the network-side device receives time information required for GNSS measurement, reported by the terminal, and sent by the network-side device to which the terminal is most recently connected.

The time information required for GNSS measurement and reported by the terminal is used to determine the fifth time information.

In embodiments of this application, the network-side device to which the terminal is most recently connected may also be referred to as a network-side device to which the terminal is connected most recently previously.

In some embodiments of this application, optionally, for the RRC connection setup scenario, the terminal has not reported the time period required for GNSS measurement to the network-side device. In this case, the network-side device needs to configure the fifth time information. Optionally, the fifth time information may be configured as a maximum time period currently supported for GNSS measurement, for example, 31 seconds.

In other embodiments of this application, optionally, for the RRC connection resume/RRC connection reestablishment/handover scenario, although the terminal has reported the time period required for GNSS measurement to the most recently previously connected network-side device, a currently connected network-side device of the terminal cannot obtain the time period required for GNSS measurement from the network-side device to which the terminal is connected most recently previously. In this case, the network-side device needs to configure the fifth time information. Optionally, the fifth time information may be configured as a maximum time period currently supported for GNSS measurement, for example, 31 seconds.

In other embodiments of this application, optionally, for the RRC connection resume/RRC connection reestablishment/handover scenario, the terminal has reported the time period required for GNSS measurement to the most recently previously connected network-side device, and a currently connected network-side device of the terminal can obtain the time period required for GNSS measurement from the network-side device to which the terminal is connected most recently previously. The currently connected network-side device of the terminal configures the fifth time information based on the time period required for GNSS measurement obtained from the network-side device to which the terminal is connected most recently previously. The currently connected network-side device of the terminal may obtain the time period required for GNSS measurement from the network-side device to which the terminal is connected most recently previously in at least one of the following ways:
The currently connected network-side device sends a first request to the network-side device to which the terminal is connected most recently previously, where the first request is used to request time information required for GNSS measurement and reported by the terminal; and
the currently connected network-side device receives time information required for GNSS measurement, reported by the terminal, and sent by the network-side device to which the terminal is connected most recently previously.

In embodiments of this application, optionally, the fifth time information is carried by using an RRC message.

In embodiments of this application, optionally, under the condition of the first indication being carried by using a first RRC message, the first RRC message further carries the fifth time information.

The GNSS measurement method provided by embodiments of this application may be performed by a GNSS measurement apparatus. The GNSS measurement apparatus provided by embodiments of this application is described in embodiments of this application by using the GNSS measurement apparatus performing the GNSS measurement method as an example.

Refer to FIG. 4. An embodiment of this application further provides a GNSS measurement apparatus 40, including:
a first processing module 41, configured to perform GNSS measurement under the condition of a first condition being satisfied.

The first condition includes any one of the following:
The terminal has received a first indication and first time information that are sent by a network-side device;
the terminal has received a first indication sent by a network-side device; or
the terminal has received first time information sent by a network-side device.

The first indication indicates that the network-side device enables GNSS measurement of the terminal, and the first time information is time information for the terminal to perform GNSS measurement.

In embodiments of this application, it is clarified when the terminal can perform GNSS measurement, or in other words, when to activate a GNSS measurement function, so that the terminal can perform GNSS measurement in a timely manner, avoiding a communication fault caused by out-of-date GNSS positioning.

Optionally, under the condition of the first condition including that the terminal has received the first indication and the first time information that are sent by the network-side device, the GNSS measurement apparatus 40 further includes:
a second processing module, configured to: under the condition of the first indication sent by the network-side device being received but the first time information sent by the network-side device being not received, skip performing GNSS measurement.

Optionally, the performing, by the terminal, GNSS measurement includes: The GNSS measurement function is activated.

Optionally, the skipping, by the terminal, performing GNSS measurement includes: GNSS measurement is not activated.

Optionally, the GNSS measurement apparatus 40 further includes:
a first execution module, configured to: under the condition of the terminal skipping performing GNSS measurement and GNSS positioning of the terminal being out of date, perform at least one of the following operations:
leaving RRC connected mode; and
entering RRC idle mode.

Optionally, the first time information is carried by using an RRC message or a media access control control element (MAC CE).

Optionally, the first time information includes time length information.

Optionally, under the condition of the first condition including that the terminal has received the first indication and the first time information that are sent by the network-side device, the GNSS measurement apparatus 40 further includes:
a second execution module, configured to perform GNSS measurement based on the first time information.

Optionally, a start time point for the performing GNSS measurement is within a time period in which an inactive state of connected mode discontinuous reception (C-DRX) of the terminal is located.

Optionally, a start time point for the performing GNSS measurement is a time point at which the first time information is received.

Optionally, under the condition of the first condition including that the terminal has received the first indication sent by the network-side device, the GNSS measurement apparatus 40 further includes:
an obtaining module, configured to: under the condition of the first time information sent by the network-side device being not received, obtain second time information, where the second time information is time information for the terminal to perform GNSS measurement.

The terminal obtains the second time information in one of the following ways:
using third time information as the second time information, where the third time information is agreed upon by a protocol;
using most recently reported fourth time information as the second time information, where the fourth time information is time information required for the terminal to perform GNSS measurement; and
using fifth time information as the second time information, where the fifth time information is configured by the network-side device.

Optionally, the second time information includes time length information.

Optionally, the time length information includes timer information, time interval information, time window information, or period information.

Optionally, the fourth time information is the fourth time information reported by the terminal to a currently connected network or a most recently connected network.

Optionally, the fifth time information is carried by using an RRC message.

Optionally, under the condition of the first indication being carried by using a first RRC message, the first RRC message further carries the fifth time information.

Optionally, under the condition of the second time information being obtained by using the fifth time information as the second time information, the GNSS measurement apparatus 40 further includes:
a third execution module, configured to: under the condition of the fifth time information configured by the network-side device being not received, perform at least one of the following operations:
considering a value of the second time information to be 0;
skipping performing GNSS measurement;
considering that a current camped or connected cell is barred from camping or connection;
leaving RRC connected mode; and
entering RRC idle mode.

Optionally, the GNSS measurement apparatus 40 further includes:
a third processing module, configured to: after the terminal leaves RRC connected mode or enters RRC idle mode, under the condition of remaining valid time of GNSS positioning being less than or equal to a preset time threshold, skip initiating at least one of the following operations:
connection setup;
connection resume;
connection reestablishment; and
handover.

Optionally, the GNSS measurement apparatus 40 further includes:
a fourth execution module, configured to perform GNSS measurement based on the second time information.

Optionally, a start time point for the performing GNSS measurement is within a time period in which an inactive state of connected mode C-DRX of the terminal is located.

Optionally, the GNSS measurement apparatus 40 further includes:
a fifth execution module, configured to: under the condition of the first time information sent by the network-side device being received, perform GNSS measurement based on the first time information.

Optionally, GNSS measurement includes at least one of the following:
autonomous GNSS measurement; and
network-triggered GNSS measurement.

The GNSS measurement apparatus in this embodiment of this application may be an electronic device, for example, an electronic device with an operating system, or a component in an electronic device, for example, an integrated circuit or a chip. The electronic device may be a terminal or another device excluding a terminal. For example, the terminal may include but is not limited to the types of the terminal 11 listed above. The another device may be a server, a network attached storage (NAS), or the like. This is not specifically limited in embodiments of this application.

The GNSS measurement apparatus provided by this embodiment of this application can implement each process implemented by the method embodiment in FIG. 2, and same technical effect is achieved. To avoid repetition, details are not described herein again.

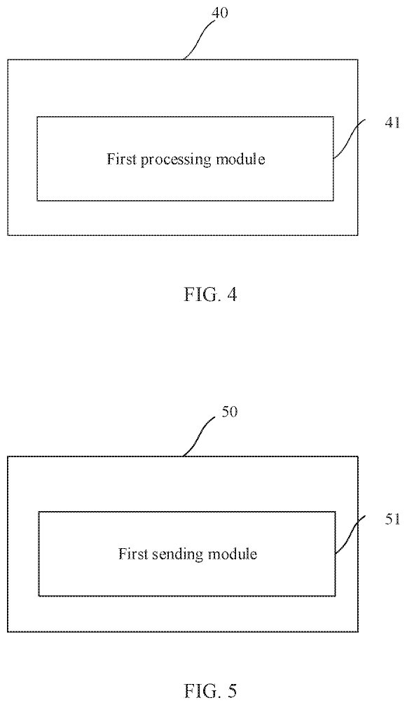

Refer to FIG. 5. An embodiment of this application further provides a GNSS measurement apparatus 50, including:
a first sending module 51, configured to send at least one of the following to a terminal: a first indication and first time information.

The first indication indicates that the network-side device enables GNSS measurement of the terminal, and the first time information is time information for the terminal to perform GNSS measurement.

That the first indication is received is a first condition for the terminal to perform GNSS measurement, or that the first indication and the first time information are received is a first condition for the terminal to perform GNSS measurement, or that the first time information is received is a first condition for the terminal to perform GNSS measurement.

Optionally, the first time information is carried by using an RRC message or a MAC CE.

Optionally, the first time information includes time length information.

Optionally, the GNSS measurement apparatus 50 further includes:
a second sending module, configured to send fifth time information to the terminal, where the fifth time information is time information that is configured by the network-side device for the terminal under the condition of the first time information being not sent and for the terminal to perform GNSS measurement.

Optionally, the fifth time information includes time length information.

Optionally, the time length information includes timer information, time interval information, time window information, or period information.

Optionally, the GNSS measurement apparatus 50 further includes at least one of the following:
a third sending module, configured to send a first request to a network-side device to which the terminal is most recently connected, where the first request is used to request time information required for GNSS measurement and reported by the terminal; and
a receiving module, configured to receive time information required for GNSS measurement, reported by the terminal, and sent by the network-side device to which the terminal is most recently connected.

The time information required for GNSS measurement and reported by the terminal is used to determine the fifth time information.

Optionally, the fifth time information is carried by using an RRC message.

Optionally, under the condition of the first indication being carried by using a first RRC message, the first RRC message further carries the fifth time information.

The GNSS measurement apparatus in this embodiment of this application may be an electronic device, for example, an electronic device with an operating system, or a component in an electronic device, for example, an integrated circuit or a chip.

The GNSS measurement apparatus provided in this embodiment of this application can implement each process implemented by the method embodiment in FIG. 3, and same technical effect is achieved. To avoid repetition, details are not described herein again.

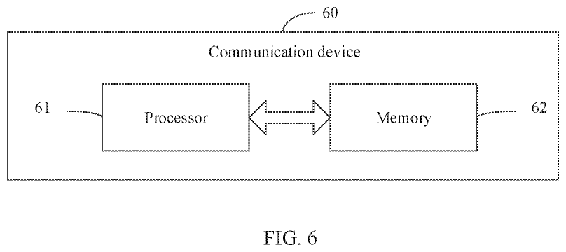

As shown in FIG. 6, an embodiment of this application further provides a communication device 60, including a processor 61 and a memory 62. A program or instructions runnable on the processor 61 are stored on the memory 62. For example, when the communication device 60 is a terminal, the program or instructions, when executed by the processor 61, implement each step in the embodiment of the GNSS measurement method performed by the terminal described above, and same technical effect can be achieved. When the communication device 60 is a network-side device, the program or instructions, when executed by the processor 61, implement each step in the embodiment of the GNSS measurement method performed by the network-side device described above, and same technical effect can be achieved. To avoid repetition, details are not described herein again.

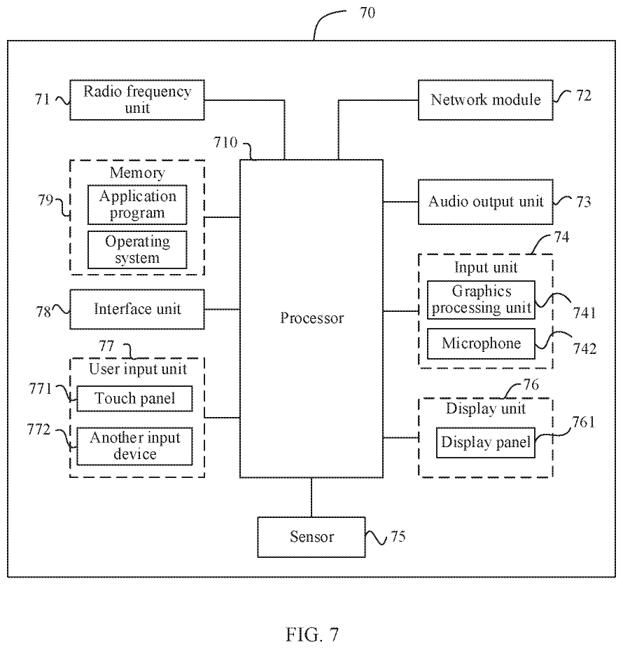

An embodiment of this application further provides a terminal, including a processor and a communication interface. The communication interface is coupled to the processor. The processor is configured to run a program or instructions to implement the steps in the method embodiment shown in FIG. 2. This terminal embodiment corresponds to the above-mentioned terminal-side method embodiment. Each implementation process and implementation of the above-mentioned method embodiment is applicable to this terminal embodiment, and same technical effect can be achieved. Specifically, FIG. 7 is a schematic diagram of a hardware structure of a terminal implementing an embodiment of this application.

The terminal 70 includes but is not limited to at least a part of the following components: a radio frequency unit 71, a network module 72, an audio output unit 73, an input unit 74, a sensor 75, a display unit 76, a user input unit 77, an interface unit 78, a memory 79, a processor 710, and the like.

Persons skilled in the art can understand that the terminal 70 may further include a power supply (such as a battery) for supplying power to each component. The power supply may be logically connected to the processor 710 through a power management system, thereby implementing functions such as charging, discharging, and power consumption management through the power management system. The terminal structure shown in FIG. 7 does not constitute a limitation on the terminal. The terminal may include more or fewer components than those shown in the figure, or combine some components, or arrange different components. Details are not described herein.

It should be understood that, in embodiments of this application, the input unit 74 may include a graphics processing unit (GPU) 741 and a microphone 742. The graphics processing unit 741 processes image data of a still picture or video obtained by an image capture device (such as a camera) in a video capture mode or an image capture mode. The display unit 76 may include a display panel 761. The display panel 761 may be configured in the form of a liquid crystal display, an organic light-emitting diode, or the like. The user input unit 77 includes at least one of: a touch panel 771 and another input device 772. The touch panel 771 is also referred to as a touch screen. The touch panel 771 may include two parts: a touch detection device and a touch controller. The another input device 772 may include but is not limited to a physical keyboard, a function key (such as a volume control key or a switch key), a trackball, a mouse, a joystick, or the like. Details are not described herein.

In embodiments of this application, after receiving downlink data from a network-side device, the radio frequency unit 71 can transmit the downlink data to the processor 710 for processing. In addition, the radio frequency unit 71 can send uplink data to the network-side device. Generally, the radio frequency unit 71 includes but is not limited to an antenna, an amplifier, a transceiver, a coupler, a low noise amplifier, a duplexer, or the like.

The memory 79 can be used to store a software program or instructions as well as various data. The memory 79 may mainly include a first storage area storing the program or instructions and a second storage area storing the data. The first storage area may store an operating system, an application program or instructions required for at least one function (such as a sound playback function or an image playback function). In addition, the memory 79 may include a volatile memory or non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous connection dynamic random access memory (Synch link DRAM, SLDRAM), or a direct memory bus random access memory (Direct Rambus RAM, DRRAM). The memory 79 in embodiments of this application includes but is not limited to these and any other suitable types of memories.

The processor 710 may include one or more processing units. Optionally, the processor 710 integrates an application processor and a modem processor. The application processor mainly processes operations that are related to an operating system, a user interface, and an application program, and the modem processor mainly processes wireless communication signals, such as a baseband processor. It can be understood that the above-mentioned modem processor may not be integrated into the processor 710.

The processor 710 is configured to: under the condition of a first condition being satisfied, perform GNSS measurement by the terminal.

The first condition includes any one of the following:

The terminal has received a first indication and first time information that are sent by a network-side device;
the terminal has received a first indication sent by a network-side device; or
the terminal has received first time information sent by a network-side device.

The first indication indicates that the network-side device enables GNSS measurement of the terminal, and the first time information is time information for the terminal to perform GNSS measurement.

In embodiments of this application, it is clarified when the terminal can perform GNSS measurement, or in other words, when to activate the GNSS measurement function, so that the terminal can perform GNSS measurement in a timely manner, avoiding a communication fault caused by out-of-date GNSS positioning.

It can be understood that the implementation processes of the various implementations mentioned in this embodiment can refer to the relevant descriptions of method embodiment 2, and same or corresponding technical effect is achieved. To avoid repetition, details are not described herein again.

An embodiment of this application further provides a network-side device, including a processor and a communication interface. The communication interface is coupled to the processor. The processor is configured to run a program or instructions to implement the steps in the method embodiment shown in FIG. 3. This network-side device embodiment corresponds to the above-mentioned network-side device method embodiment. Each implementation process and implementation of the above-mentioned method embodiment is applicable to this network-side device embodiment, and same technical effect can be achieved.

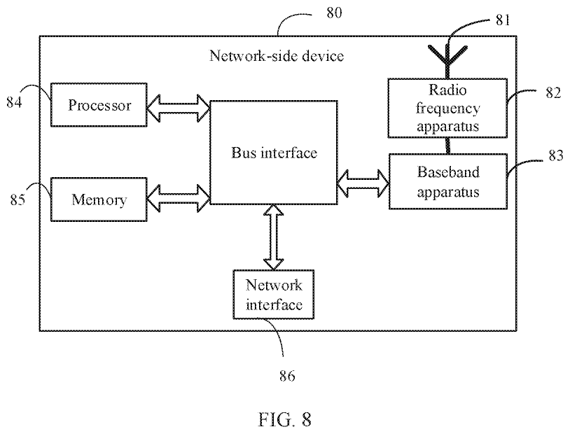

Specifically, an embodiment of this application further provides a network-side device. As shown in FIG. 8, the network-side device 80 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81 and sends the received information to the baseband apparatus 83 for processing. In a downlink direction, the baseband apparatus 83 processes to-be-sent information and sends processed information to the radio frequency apparatus 82. After processing the received information, the radio frequency apparatus 82 sends processed information out through the antenna 81.

The method performed by the network-side device in the above embodiments can be implemented by the baseband apparatus 83. The baseband apparatus 83 includes a baseband processor.

The baseband apparatus 83 may, for example, include at least one baseband board on which multiple chips are disposed. As shown in FIG. 8, one of the chips is, for example, a baseband processor, connected to the memory 85 through a bus interface, to call a program in the memory 85 and perform the network device operations shown in the above method embodiments.

The network-side device may further include a network interface 86, which is, for example, a common public radio interface (CPRI).

Specifically, the network-side device 80 of the embodiment of this application further includes: instructions or a program stored on the memory 85 and runnable on the processor 84. The processor 84 calls the instructions or program in the memory 85 to perform the methods performed by the modules shown in FIG. 5, and same technical effect is achieved. To avoid repetition, details are not described herein again.

An embodiment of this application further provides a readable storage medium. A program or instructions are stored on the readable storage medium. When the program or instructions are executed by a processor, each process of the above-mentioned embodiments of the GNSS measurement method can be implemented, and same technical effect can be achieved. To avoid repetition, details are not described herein again.

The processor is the processor in the terminal described in the above embodiments. The readable storage medium includes a computer-readable storage medium, such as a computer read-only memory (ROM), a random access memory (RAM), a magnetic disk, an optical disk, or the like. In some examples, the readable storage medium may be a non-transitory readable storage medium.

An embodiment of this application further provides a chip. The chip includes a processor and a communication interface. The communication interface is coupled to the processor. The processor is configured to run a program or instructions to implement each process of the above-mentioned embodiments of the GNSS measurement method, and same technical effect is achieved. To avoid repetition, details are not described herein again.

It should be understood that the chip mentioned in embodiments of this application may also be referred to as a system-level chip, a system chip, a chip system, a system-on-chip, or the like.

An embodiment of this application further provides a computer program/program product. The computer program/program product is stored in a storage medium. The computer program/program product is executed by at least one processor to implement each process of the above-mentioned embodiments of the GNSS measurement method, and same technical effect is achieved. To avoid repetition, details are not described herein.

An embodiment of this application further provides a wireless communication system, including a terminal and a network-side device. The terminal may be configured to perform the steps of the GNSS measurement method performed by the terminal as described above. The network-side device may be configured to perform the steps of the GNSS measurement method performed by the network-side device as described above.

It should be noted that, in this specification, the term “include”, “comprise”, or any other variant thereof is intended to cover non-exclusive inclusion, so that a process, method, article, or apparatus including a series of elements not only includes those elements, but also includes other elements not explicitly listed, or includes elements inherent to such a process, method, article or apparatus. Without further limitation, an element defined by the statement “including a . . . ” does not exclude the presence of other identical elements in the process, method, article or apparatus that includes the element. In addition, it should be noted that the scope of the methods and apparatuses in embodiments of this application is not limited to performing functions in the order shown or discussed, or may include performing functions substantially simultaneously or in the reverse order according to the functions involved. For example, the described method may be performed in a different order than described, and various steps may also be added, omitted, or combined. In addition, features described with reference to certain examples may be combined in other examples.

Through the description of the above implementations, persons skilled in the art can clearly understand that the method of the above embodiments may be implemented by means of a computer software product plus a necessary general hardware platform, or certainly may be implemented by hardware. The computer software product is stored in a storage medium (such as a ROM, a RAM, a magnetic disk, or an optical disk) and includes instructions for making a terminal or a network-side device perform the methods described in embodiments of this application.

Embodiments of this application are described above with reference to the accompanying drawings, but this application is not limited to the specific embodiments described above. The specific embodiments described above are only illustrative, not restrictive. Persons of ordinary skill in the art can make various forms of embodiments under the inspiration of this application without departing from the purpose and scope of protection of this application and the claims. All these embodiments belong to the protection of this application.

What is claimed is:

1. A global navigation satellite system (GNSS) measurement method, comprising:
performing, by a terminal, GNSS measurement under a first condition being satisfied, wherein
the first condition comprises any one of the following:
the terminal has received a first indication and first time information that are sent by a network-side device;
the terminal has received the first indication sent by the network-side device; or
the terminal has received the first time information sent by the network-side device, wherein
the first indication indicates that the network-side device enables the GNSS measurement of the terminal, and the first time information is time information for the terminal to perform the GNSS measurement.

2. The method according to claim 1, wherein under the condition of the first condition comprising that the terminal has received the first indication and the first time information that are sent by the network-side device, the method further comprises:
under the condition of the first indication sent by the network-side device being received but the first time information sent by the network-side device being not received, skipping, by the terminal, performing the GNSS measurement.

3. The method according to claim 2, further comprising:
under the condition of the terminal skipping performing the GNSS measurement and GNSS positioning of the terminal being out of date, performing, by the terminal, at least one of the following operations:
leaving radio resource control (RRC) connected mode; or
entering RRC idle mode.

4. The method according to claim 1, comprising at least one of the following:
the performing, by the terminal, the GNSS measurement comprises: a GNSS measurement function is activated; or
skipping, by the terminal, performing the GNSS measurement comprises: GNSS measurement is not activated.

5. The method according to claim 1, wherein under the condition of the first condition comprising that the terminal has received the first indication sent by the network-side device, the method further comprises:
under the condition of the first time information sent by the network-side device being not received, obtaining, by the terminal, second time information, wherein the second time information is the time information for the terminal to perform the GNSS measurement.

6. The method according to claim 5, wherein the terminal obtains the second time information in one of the following ways:
using third time information as the second time information, wherein the third time information is specified by a protocol;
using most recently reported fourth time information as the second time information, wherein the fourth time information is the time information required for the terminal to perform the GNSS measurement; or
using fifth time information as the second time information, wherein the fifth time information is configured by the network-side device.

7. The method according to claim 6, wherein the fourth time information is time information reported by the terminal to a currently connected network or a most recently connected network.

8. The method according to claim 6, wherein the fifth time information is carried by using an RRC message.

9. The method according to claim 8, wherein under the condition of the first indication being carried by using a first RRC message, the first RRC message further carries the fifth time information.

10. The method according to claim 6, wherein under the condition of the second time information being obtained by using the fifth time information as the second time information, the method further comprises:
under the condition of the fifth time information configured by the network-side device being not received, performing, by the terminal, at least one of the following operations:
considering a value of the second time information to be 0;
skipping performing the GNSS measurement;
considering that a current camped or connected cell is barred from camping or connection;
leaving RRC connected mode; or
entering RRC idle mode.

11. The method according to claim 10, further comprising: after the terminal leaves the RRC connected mode or enters the RRC idle mode, under the condition of remaining valid time of GNSS positioning being less than or equal to a preset time threshold, skipping initiating at least one of the following operations:
connection setup;
connection resume;
connection reestablishment; or
handover.

12. The method according to claim 5, wherein the second time information comprises time length information.

13. The method according to claim 12, wherein the time length information comprises timer information, time interval information, time window information, or period information.

14. The method according to claim 5, further comprising:
performing, by the terminal, the GNSS measurement based on the second time information.

15. The method according to claim 14, further comprising:
time for the performing GNSS measurement is within a time period in which an inactive state of connected mode connected mode discontinuous reception (C-DRX) of the terminal is located.

16. The method according to claim 5, further comprising:
under the condition of the first time information sent by the network-side device being received, performing, by the terminal, the GNSS measurement based on the first time information.

17. A readable storage medium, wherein a program or instructions are stored on the readable storage medium; and when executed by a processor, the program or instructions implement the GNSS measurement method according to claim 1.

18. A global navigation satellite system (GNSS) measurement method, comprising:
sending, by a network-side device, at least one of the following to a terminal: a first indication or first time information, wherein
the first indication indicates that the network-side device enables GNSS measurement of the terminal, and the first time information is time information for the terminal to perform the GNSS measurement; and
that the first indication is received is a first condition for the terminal to perform the GNSS measurement, or that the first indication and the first time information are received is a first condition for the terminal to perform the GNSS measurement, or that the first time information is received is the first condition for the terminal to perform the GNSS measurement.

19. The network-side device, comprising a processor and a memory, wherein the memory stores a program or instructions runnable on the processor; and when executed by the processor, the program or instructions implement the steps of the GNSS measurement method according to claim 18.

20. A terminal, comprising a processor and a memory, wherein the memory stores a program or instructions runnable on the processor; and when executed by the processor, the program or instructions implement operations comprising:
performing, global navigation satellite system (GNSS) measurement under a first condition being satisfied, wherein
the first condition comprises any one of the following:
the terminal has received a first indication and first time information that are sent by a network-side device;
the terminal has received the first indication sent by the network-side device; or
the terminal has received first time information sent by the network-side device, wherein
the first indication indicates that the network-side device enables GNSS measurement of the terminal, and the first time information is time information for the terminal to perform the GNSS measurement.
